(19) United States
(12) Patent Application Publication
(10) Pub. No.: US 2008/0218487 A1
(43) Pub. Date: Sep. 11, 2008

(54) Capacitive-type touch pad having special arrangement of capacitance sensor

(76) Inventors: Chun-Chung Huang, Hsin-Chu City (TW); Tsun-Min Wang, Hsin-Chu City (TW); Tse-Chi Lin, Hsin-Chu City (TW); Chun-Yu Lin, Hsin-Chu City (TW)

Correspondence Address: HDSL, 4331 STEVENS BATTLE LANE, FAIRFAX, VA, 22033, US

(21) Appl. No.: 11/778,772

(22) Filed: Jul. 17, 2007

Related U.S. Application Data
(60) Provisional application No. 60/893,623, filed on Mar. 7, 2007.

(51) Int. Cl. G06F 3/041

(52) U.S. Cl. 345/173

(57) ABSTRACT

A touch pad has a controller circuitry for generating an X-Y coordinate signal; a touch screen connecting with the controller circuitry, which has a transparent substrate and a transparent conductive film provided at the transparent substrate. The transparent conductive film having a plurality of capacitance sensors distributed along an X-coordinate direction and a Y-coordinate direction. The plurality of capacitance sensors are patterned for averaging the resistance capacitance distribution.

### CROSS-REFERENCE

This application claims priority from U.S. Provisional Patent Application No 60/893,623, filed on Mar. 7, 2007.

### BACKGROUND

The present invention relates to touch pads for display devices. More particularly, the present invention relates to capacitive-type touch pads for display devices.

Touch pads have been developed as a means of efficiently interfacing with electronic devices via a display surface. For example, users may input desired information using a touch pad integrated with a display device while watching images displayed by the display device. Allowing users to input desired information to an electronic device via a display surface, touch pads substantially reduce or eliminate the need for other types of input devices (e.g., keyboards, mice, remote controllers, and the like). Currently, touch pads have been widely integrated with display surfaces of flat panel display devices such as liquid crystal display (LCD) devices, plasma display panel (PDP) devices, electroluminescence (EL) devices, and cathode ray tubes (CRTs).

Depending on the type of contact object used (e.g., an user's finger, a stylus, etc.), and depending on the manner in which the location of a contact point (i.e., the location where the contact object is operably proximate the touch pad) is determined, touch pads are generally classifiable as analog resistive-type, capacitive-type, electromagnetic (EM)-type, saw-type, and infrared-type touch pads.

Generally, analog resistive-type touch pads include an upper transparent substrate supporting an upper electrode and a lower transparent substrate supporting a lower electrode. The upper and lower transparent substrates are attached to each other but spaced apart from each other by a predetermined distance. When a surface of the upper transparent substrate is contacted by a contact object, an upper electrode formed on the upper transparent substrate electrically contacts a lower electrode formed on the lower transparent substrate. When the upper and lower electrodes electrically contact each other, a voltage, made variable by a resistance value or a capacitance value specific to the location of where the contact object contacted the touch pad (i.e., the contact point), is then detected and outputted along with a location defined by coordinates of the contact point.

Generally, capacitive-type touch pads include a plurality of capacitance sensors which are realized by a printed circuit board (PCB). Coordinates of the contact point are determined in accordance with capacitance change generated when the user touches the touch pad via the contact object. However, generally PCB is opaque, which limit the use scope of the capacitive-type touch pads, such as mobile phone, personal Digital Assistant (PDA), display, etc. Therefore, a transparent conductive film is utilized, such as indium tin oxide (ITO) conductive film, indium zinc oxide (IZO) conductive film, which are formed on a display device such as an LCD panel, wherein a voltage is applied to each corner or side of the transparent electrode conductive film and a uniform electric field is thereby generated within the transparent electrode. Coordinates of the contact point are determined in accordance with a voltage drop generated when the user touches the touch pad via the contact object.

However, ITO conductive film or IZO conductive film generally has a resistance, which can not be ignored. When the ITO conductive film or IZO conductive film is utilized as a capacitance sensor, it produces a resistance capacitance (RC) filtering effect. Thus, the capacitance sensor far away a control circuit can not precisely detect the capacitance change, which made the control or adjustment of the capacitive-type touch pads imprecisely. Especially, the capacitance sensor far away a control circuit can not detect the capacitance change if it is disposed under a thicker medium.

Accordingly, what is needed is a capacitive-type touch pad that can overcome the above-described deficiencies.

### BRIEF SUMMARY

A touch pad has a controller circuitry for generating an X-Y coordinate signal; a touch screen connecting with the controller circuitry, which has a transparent substrate and a transparent conductive film provided at the transparent substrate. The transparent conductive film having a plurality of capacitance sensors distributed along an X-coordinate direction and a Y-coordinate direction. The plurality of capacitance sensors are patterned for averaging the resistance capacitance distribution.

Other advantages and novel features will become more apparent from the following detailed description when taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 essentially is a circuit diagram of a capacitive-type touch pad according to a first embodiment of the present invention, which has a transparent conductive film having a plurality of capacitance sensors formed thereon.

FIG. 2A is an explanatory drawing showing a first arrangement of the plurality of capacitance sensors distributed along X-coordinate direction of the transparent conductive film.

FIG. 2B is an explanatory drawing showing a first arrangement of the plurality of capacitance sensors distributed along Y-coordinate direction of the transparent conductive film.

FIG. 3A is an explanatory drawing showing a second arrangement of the plurality of capacitance sensors distributed along X-coordinate direction of the transparent conductive film.

FIG. 3B is an explanatory drawing showing a second arrangement of the plurality of capacitance sensors distributed along Y-coordinate direction of the transparent conductive film.

FIG. 4A is an explanatory drawing showing a third arrangement of the plurality of capacitance sensors distributed along X-coordinate direction of the transparent conductive film.

FIG. 4B is an explanatory drawing showing a third arrangement of the plurality of capacitance sensors distributed along Y-coordinate direction of the transparent conductive film.

FIG. 5A is an explanatory drawing showing a fourth arrangement of the plurality of capacitance sensors distributed along X-coordinate direction of the transparent conductive film.

FIG. 5B is an explanatory drawing showing a fourth arrangement of the plurality of capacitance sensors distributed along Y-coordinate direction of the transparent conductive film.

FIG. 6 is an explanatory drawing showing an alternate shape of the plurality of capacitance sensors distributed along X-coordinate direction or Y-coordinate direction of the transparent conductive film.

FIG. 7 is an explanatory drawing showing another alternate of the plurality of capacitance sensors distributed along Y-coordinate direction of the transparent conductive film.

FIG. 8 shows a sequence of detecting the plurality of capacitance sensors.

FIG. 9 shows another sequence of detecting the plurality of capacitance sensors.

### DETAILED DESCRIPTION

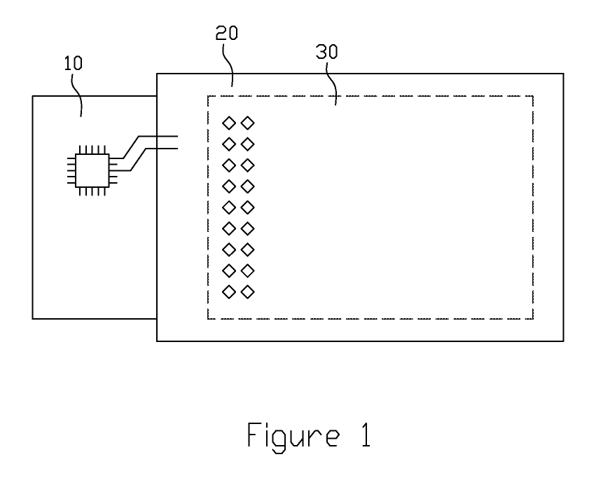

Turning now to the drawings in greater detail, there is illustrated in FIG. 1 an exemplary environment within which an embodiment, of a touch pad, screen or system in accordance with the present invention is utilized. The touch pad having a surface which is adapted to be touched by an user and which is positionable in a stationary condition across a screen of a display, which includes a flexible printed circuit board (FPCB) 10 and a touch screen 20. The FPCB 10 has a controller circuitry formed thereon, which is used to supply stimulating electrical signals to touch screen 20 and to generate an X-Y coordinate signal which corresponds with the location (i.e. the point) within the touch screen 20 at which the touch screen 20 is touched by an user. Such coordinate signals may be used by a computer to initiate a desired, i.e. a predetermined, command within the computer. The touch screen 20 has a transparent insulating substrate made of glass, on which is provided a transparent conductive film 30, such as ITO conductive film, IZO conductive film or a membrane comprising coal conductive film or silver tapes.

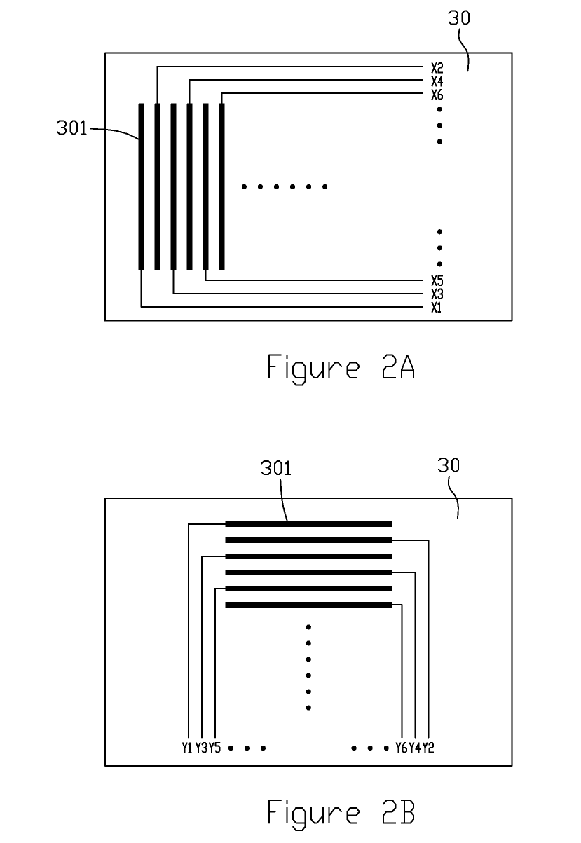

The transparent conductive film 30 has a plurality of capacitance sensors 301 distributed along an X-coordinate direction and a Y-coordinate direction. FIG. 2A is an explanatory drawing showing a first arrangement of the plurality of capacitance sensors 301 distributed along X-coordinate direction of the transparent conductive film 30, and FIG. 2B is an explanatory drawing showing a first arrangement of the plurality of capacitance sensors 301 distributed along Y-coordinate direction of the transparent conductive film 30. The plurality of capacitance sensors 301 is strip-shaped, which has X-coordinate direction capacitance sensors X1 . . . Xn and Y-coordinate direction capacitance sensors Y1 . . . Yn. The X-coordinate direction and Y-coordinate direction capacitance sensors X1 . . . Xn, Y1 . . . Yn can be formed at a same layer of the touch screen 20 or be formed at two different layers of the touch screen 20. The X-coordinate direction capacitance sensors X1 . . . Xn are arranged along the X-coordinate direction, parallel to each other and spacing a predetermined distance. Each X-coordinate direction capacitance sensor X1 . . . Xn connects with a pin of the controller circuitry on the FPCB 10 through conductive wire. The Y-coordinate direction capacitance sensors Y1 . . . Yn are arranged along the Y-coordinate direction, parallel to each other and spacing a predetermined distance. Each Y-coordinate direction capacitance sensor Y1 . . . Yn connects with a pin of the controller circuitry on the FPCB 10 through conductive wire. The controller circuitry scans two adjacent X-coordinate direction capacitance sensors or Y-coordinate direction capacitance sensors once. Thus, when the controller circuitry scans two adjacent X-coordinate direction capacitance sensors Xi, Xi+1 (1≦i≦n−1), the resistance capacitance distribution at the two adjacent X-coordinate direction capacitance sensors is same no matter where the touch point is at the Y-coordinate direction. In addition, the Y-coordinate direction capacitance sensors have the same function.

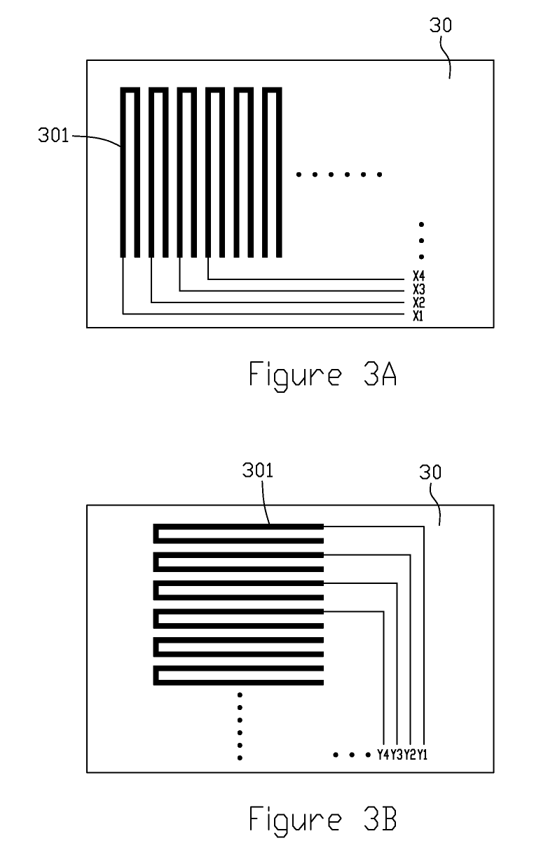

FIG. 3A is an explanatory drawing showing a second arrangement of the plurality of capacitance sensors distributed along X-coordinate direction of the transparent conductive film, and FIG. 3B is an explanatory drawing showing a second arrangement of the plurality of capacitance sensors distributed along Y-coordinate direction of the transparent conductive film. The plurality of capacitance sensors 301 is U-shaped, which has X-coordinate direction capacitance sensors X1 . . . Xn and Y-coordinate direction capacitance sensors Y1 . . . Yn. The X-coordinate direction and Y-coordinate direction capacitance sensors X1 . . . Xn, Y1 . . . Yn can be formed at a same layer of the touch screen 20 or be formed at two different layers of the touch screen 20. The X-coordinate direction capacitance sensors X1 . . . Xn are arranged along the X-coordinate direction, parallel to each other and spacing a predetermined distance. Each X-coordinate direction capacitance sensor X1 . . . Xn connects with a pin of the controller circuitry on the FPCB 10 through conductive wire. The Y-coordinate direction capacitance sensors Y1 . . . Yn are arranged along the Y-coordinate direction, parallel to each other and spacing a predetermined distance. Each Y-coordinate direction capacitance sensor Y1 . . . Yn connects with a pin of the controller circuitry on the FPCB 10 through conductive wire. The U-shaped capacitance sensor 301 average the resistance capacitance change at each capacitance sensor 301. In addition, the notch of each X-coordinate direction capacitance sensors X1 . . . Xn can be arranged at a top portion of the touch screen 20 or a bottom portion of the touch screen 20, and the notch of each Y-coordinate direction capacitance sensors Y1 . . . Yn can be arranged at a right portion of the touch screen 20 or a left portion of the touch screen 20.

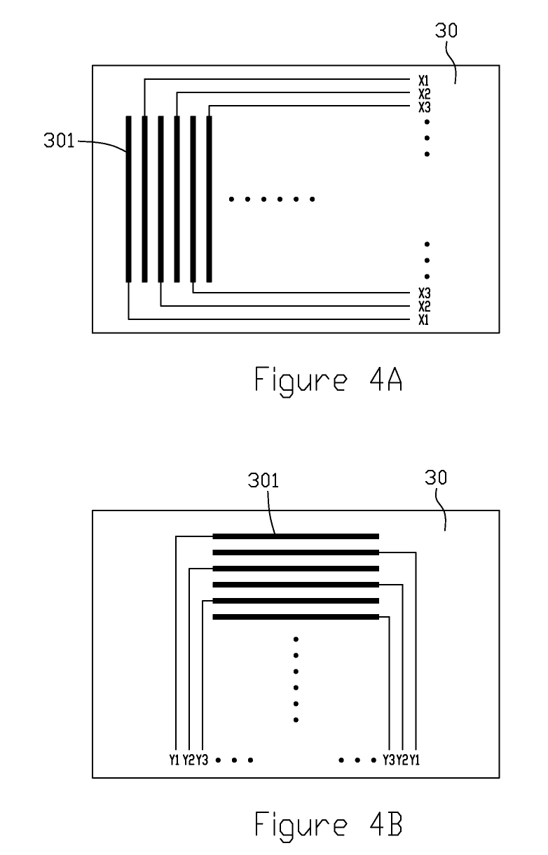

FIG. 4A is an explanatory drawing showing a first arrangement of the plurality of capacitance sensors 301 distributed along X-coordinate direction of the transparent conductive film 30, and FIG. 4B is an explanatory drawing showing a first arrangement of the plurality of capacitance sensors 301 distributed along Y-coordinate direction of the transparent conductive film 30. The plurality of capacitance sensors 301 is strip-shaped, which has X-coordinate direction capacitance sensors X1 . . . Xn and Y-coordinate direction capacitance sensors X1 . . . Xn. The X-coordinate direction and Y-coordinate direction capacitance sensors X1 . . . Xn, Y1 . . . Yn can be formed at a same layer of the touch screen 20 or be formed at two different layers of the touch screen 20. The X-coordinate direction capacitance sensors X1 . . . Xn are arranged along the X-coordinate direction, parallel to each other and spacing a predetermined distance. Two adjacent X-coordinate direction capacitance sensors Xi, Xi+1 (1≦i≦n−1) connect with a pin of the controller circuitry on the FPCB 10 through conductive wire. The Y-coordinate direction capacitance sensors Y1 . . . Yn are arranged along the Y-coordinate direction, parallel to each other and spacing a predetermined distance. Two adjacent Y-coordinate direction capacitance sensor Yi, Yi+1 (1≦i≦n−1) connect with a pin of the controller circuitry on the FPCB 10 through conductive wire. Thus, each pin of the controller circuitry controls two adjacent capacitance sensors 301. When the controller circuitry scans two adjacent X-coordinate direction capacitance sensors Xi, Xi+1 (1≦i≦n−1) once, the resistance capacitance distribution at the two adjacent X-coordinate direction capacitance sensors is same no matter where the touch point is at the Y-coordinate direction. In addition, the Y-coordinate direction capacitance sensors have the same function.

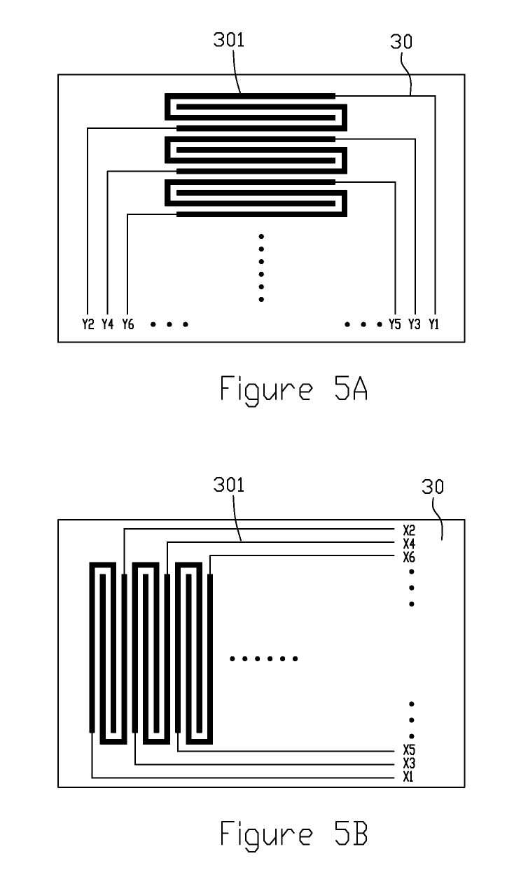

FIG. 5A is an explanatory drawing showing a fourth arrangement of the plurality of capacitance sensors distributed along X-coordinate direction of the transparent conductive film, and FIG. 5B is an explanatory drawing showing a fourth arrangement of the plurality of capacitance sensors distributed along Y-coordinate direction of the transparent conductive film. The plurality of capacitance sensors 301 is U-shaped, which has X-coordinate direction capacitance sensors X1 . . . Xn and Y-coordinate direction capacitance sensors Y1 . . . Yn. The X-coordinate direction and Y-coordinate direction capacitance sensors X1 . . . Xn, Y1 . . . Yn can be formed at a same layer of the touch screen 20 or be formed at two different layers of the touch screen 20. The X-coordinate direction capacitance sensors X1 . . . Xn are arranged along the X-coordinate direction, parallel to each other. Two adjacent X-coordinate direction capacitance sensors Xi, Xi+1 (1≦i≦n−1) nest each other. Each X-coordinate direction capacitance sensor X1 . . . Xn connects with a pin of the controller circuitry on the FPCB 10 through conductive wire. The Y-coordinate direction capacitance sensors Y1 . . . Yn are arranged along the Y-coordinate direction, parallel to each other. Two adjacent Y-coordinate direction capacitance sensors Yi, Yi+1 (1≦i≦n−1) nest each other. Each Y-coordinate direction capacitance sensor Y1 . . . Yn connects with a pin of the controller circuitry on the FPCB 10 through conductive wire. The U-shaped capacitance sensor 301 average the resistance capacitance change at each capacitance sensor 301. In addition, the notch of each X-coordinate direction capacitance sensors X1 . . . Xn can be arranged at a top portion of the touch screen 20 or a bottom portion of the touch screen 20, and the notch of each Y-coordinate direction capacitance sensors Y1 . . . Yn can be arranged at a right portion of the touch screen 20 or a left portion of the touch screen 20.

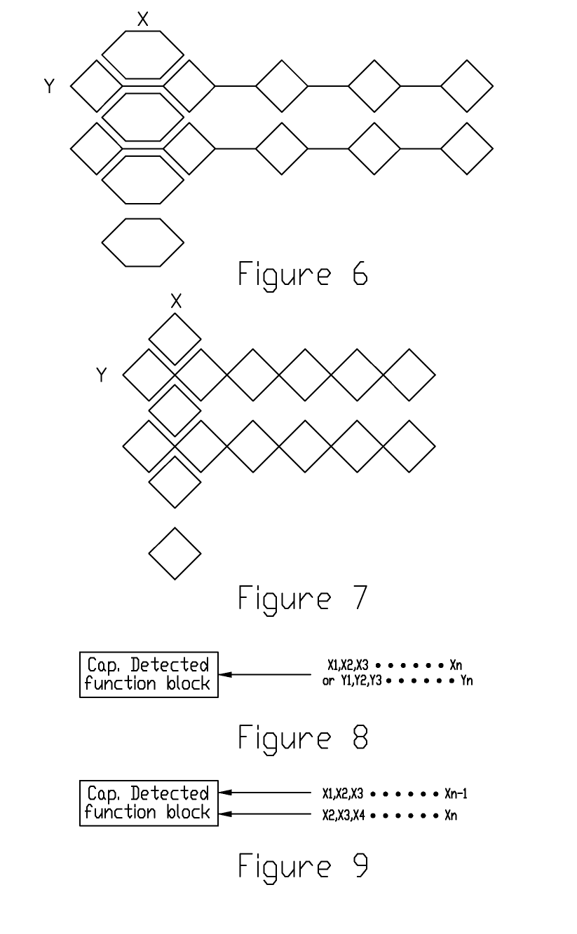

FIG. 6 is an explanatory drawing showing an alternate shape of the plurality of capacitance sensors distributed along X-coordinate direction or Y-coordinate direction of the transparent conductive film. As shown in FIG. 6, each X-coordinate direction capacitance sensor Xi has a plurality of X-coordinate direction sensor units arranged along a Y-coordinate direction, and each X-coordinate direction sensor unit has a shape of hexagon. Each Y-coordinate direction capacitance sensor Yi has a plurality of Y-coordinate direction sensor units arranged along an X-coordinate direction, two adjacent Y-coordinate direction sensor units being connected by a strip-shaped connector and each Y-coordinate direction sensor unit has a shape of quadrangle. Each hexagon-shaped X-coordinate direction sensor unit are disposed at a space surrounding by 2×2 quadrangle Y-coordinate direction sensor units.

FIG. 7 is an explanatory drawing showing another alternate shape of the plurality of capacitance sensors distributed along Y-coordinate direction of the transparent conductive film. As shown in FIG. 7 each X-coordinate direction capacitance sensor Xi has a plurality of X-coordinate direction sensor units arranged along a Y-coordinate direction, and each X-coordinate direction sensor unit has a shape of quadrangle. Each Y-coordinate direction capacitance sensor Yi has a plurality of Y-coordinate direction sensor units arranged along an X-coordinate direction, and each Y-coordinate direction sensor unit has a shape of quadrangle. Each quadrangle-shaped X-coordinate direction sensor unit are disposed at a space surrounding by 2×2 quadrangle Y-coordinate direction sensor units.

FIG. 8 shows a sequence of detecting the plurality of capacitance sensors 301. The X-coordinate direction or Y-coordinate direction capacitance sensors 301 are sequentially detected by a capacitance detected function block following the sequence of from X1 to Xn, or from Y1 to Yn. This detecting sequence adapts to the second, the third and the fourth arrangement of the plurality of capacitance sensors 301. Because the second, the third and the fourth arrangement of the plurality of capacitance sensors 301 have averaged the resistance at the whole arrangement, the equivalent resistance is same no matter where the detection point is. Therefore, the position of the detection point does not influence the circuitry.

FIG. 9 shows another sequence of detecting the plurality of capacitance sensors 301. Two X-coordinate direction capacitance sensors 301 or two Y-coordinate direction capacitance sensors 301 are detected by a capacitance detected function block each time, which follow a predetermined sequence, such as: firstly, the two X-coordinate direction capacitance sensors X1 and X2 are detected at the same time; secondly, the two X-coordinate direction capacitance sensors X2 and X3 are detected at the same time; . . . until the X-coordinate direction capacitance sensors Xn−1, Xn are detected. This detecting sequence adapts to the first, the second, the third and the fourth arrangement of the plurality of capacitance sensors 301.

In alternate embodiments, each sensor unit can also be other shapes, such as circular, triangle, other polygon. Each sensor unit can be solid or hollow, which can be adjusted according to special design needs.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch pad comprising:
a controller circuitry for generating an X-Y coordinate signal; and
a touch screen connecting with the controller circuitry, which comprises a transparent substrate and a transparent conductive film provided at the transparent substrate; the transparent conductive film comprising a plurality of capacitance sensors distributed along an X-coordinate direction and a Y-coordinate direction;
wherein the plurality of capacitance sensors are patterned for averaging the resistance capacitance distribution.

2. The touchpad as claimed in claim 1, wherein the transparent conductive film is selected from one of indium tin oxide (ITO) conductive film and indium zinc oxide (IZO) conductive film.

3. The touchpad as claimed in claim 1, wherein the plurality of capacitance sensors comprise X-coordinate direction capacitance sensors and Y-coordinate direction capacitance sensors.

4. The touchpad as claimed in claim 3, wherein the X-coordinate direction and Y-coordinate direction capacitance sensors can be formed at a same layer of the touch screen or be formed at two different layers of the touch screen.

5. The touchpad as claimed in claim 3, wherein each X-coordinate direction capacitance sensor is arranged along the X-coordinate direction, parallel to each other and spacing a predetermined distance; each Y-coordinate direction capacitance sensors is arranged along the Y-coordinate direction, parallel to each other and spacing a predetermined distance.

6. The touchpad as claimed in claim 5, further comprising a controller circuitry, which scans two adjacent X-coordinate direction capacitance sensors or Y-coordinate direction capacitance sensors once.

7. The touchpad as claimed in claim 6, wherein the plurality of capacitance sensors is strip-shaped.

8. The touchpad as claimed in claim 7, wherein each X-coordinate direction capacitance sensor connects with a pin of a controller circuitry, or two adjacent X-coordinate direction capacitance sensors connect with a pin of the controller circuitry.

9. The touchpad as claimed in claim 8, wherein each Y-coordinate direction capacitance sensor connects with a pin of the controller circuitry, or two adjacent Y-coordinate direction capacitance sensors connect with a pin of the controller circuitry.

10. The touchpad as claimed in claim 6, wherein the plurality of capacitance sensors is U-shaped.

11. The touchpad as claimed in claim 10, wherein each X-coordinate direction capacitance sensor connects with a pin of a controller circuitry.

12. The touchpad as claimed in claim 11, wherein each Y-coordinate direction capacitance sensor connects with a pin of the controller circuitry.

13. The touchpad as claimed in claim 10, wherein two adjacent X-coordinate direction capacitance sensors nest each other.

14. The touchpad as claimed in claim 13, wherein two adjacent Y-coordinate direction capacitance sensors nest each other.

15. The touchpad as claimed in claim 10, wherein the notch of each X-coordinate direction capacitance sensors can be arranged at a top portion of the touch screen or a bottom portion of the touch screen, and the notch of each Y-coordinate direction capacitance sensors can be arranged at a right portion of the touch screen or a left portion of the touch screen.

16. The touchpad as claimed in claim 3, wherein each X-coordinate direction capacitance sensor comprises a plurality of X-coordinate direction sensor units arranged along a Y-coordinate direction.

17. The touchpad as claimed in claim 16, wherein each Y-coordinate direction capacitance sensor Yi comprises a plurality of Y-coordinate direction sensor units arranged along an X-coordinate direction, two adjacent Y-coordinate direction sensor units being directly connected or being connected by a strip-shaped connector.

18. The touchpad as claimed in claim 17, wherein each X-coordinate direction sensor unit has a shape of hexagon, and each Y-coordinate direction sensor unit has a shape of quadrangle, each hexagon-shaped X-coordinate direction sensor unit being disposed at a space surrounding by 2×2 quadrangle Y-coordinate direction sensor units.

19. The touchpad as claimed in claim 17, wherein each X-coordinate direction sensor unit and Y-coordinate direction sensor unit has a shape of quadrangle, each quadrangle-shaped X-coordinate direction sensor unit being disposed at a space surrounding by 2×2 quadrangle Y-coordinate direction sensor units.

20. The touchpad as claimed in claim 3, wherein the X-coordinate direction or Y-coordinate direction capacitance sensors are sequentially detected by a capacitance detected function block, or two X-coordinate direction capacitance sensors or two Y-coordinate direction capacitance sensors are detected by a capacitance detected function block each time.
